(19) United States
(12) Patent Application Publication
(10) Pub. No.: US 2014/0143808 A1
(43) Pub. Date: May 22, 2014

(54) METHOD AND APPARATUS FOR PROVIDING MULTICASTING SERVICE FOR SPECIFIC GROUP

(71) Applicant: ELECTRONICS AND TELECOMMUNICATIONS RESEARCH INSTITUTE, (US)

(72) Inventors: Jae Hwui BAE, Daejeon-si (KR); Sang Woo AHN, Daejeon-si (KR); Woong Shik YOU, Chungcheongnam-do (KR); O Hyung KWON, Daejeon-si (KR)

(73) Assignee: ELECTRONICS AND TELECOMMUNICATIONS RESEARCH INSTITUTE, Daejeon-si (KR)

(21) Appl. No.: 13/850,657

(22) Filed: Mar. 26, 2013

(30) Foreign Application Priority Data
Nov. 19, 2012 (KR) 10-2012-0130842

(51) Int. Cl. H04N 21/85

(52) U.S. Cl. CPC H04N 21/85
USPC 725/35; 725/32

(57) ABSTRACT

The present invention discloses a multicasting broadcasting apparatus and method. In an aspect, a multicasting broadcasting method includes receiving content from a user, inspecting the content, performing IP encapsulation on the content, reconfiguring a broadcasting frame so that the content does not interfere with other broadcasting signals, generating a modulation signal comprising the content, and broadcasting the modulation signal to target receivers over a broadcasting network.

This application claims the benefit of priority of Korean Patent Application No. 10-2012-0130842 filed on Nov. 19, 2012, which is incorporated by reference in their entirety herein.

### BACKGROUND OF THE INVENTION

1. Field of the Invention

The present invention relates to digital broadcasting and, more particularly, to a method and apparatus for broadcasting multicast content to a specific group.

2. Discussion of the Related Art

In digital broadcasting, a new concept of broadcasting service that was impossible in the analog broadcasting age is possible. In digital broadcasting, High Definition TV (HDTV) service having significantly better picture quality than analog broadcasting and including high-quality sound service, such as a 5.2 channel, can be provided. Furthermore, in digital broadcasting, stereoscopic video service can also be provided through 3D HDTV service.

The development of technology for post-HDTV broadcasting, that is, broadcasting service after the HDTV age, is in progress, and the post-HDTV broadcasting is also called Ultra High Definition TV (UHDTV). UHDTV can provide stereoscopic sound service having resolution 4 to 8 times higher than HDTV and a 10.1 or 20.2 channel. 4K UHDTV having resolution 4 times higher than UHDTV can provide service through a display of 80-100 inches. 8K UHDTV having resolution 8 times higher than HDTV can provide service through a display of 80-100 inches can provide service through a display of 100 inches or more.

In contrast, in the existing broadcasting paradigm, a TV subscription fee cannot be raised although new high-quality video and stereoscopic sound broadcasting service is provided because there is no significant change. An income model of a broadcaster has no great change as compare with the analog broadcasting age. It is difficult for a broadcaster to secure a new revenue source because revenue sources still rely on advertising revenues even though content production costs are high.

This high-quality content production costs and advertising revenues equal to those of analog broadcasting can be a burden on a broadcaster in the post-HDTV broadcasting age, and a broadcaster requires a broadcasting paradigm that enables a new business. For this reason, in the post-HDTV age, a broadcaster requires a broadcasting paradigm capable of securing a new revenue source.

### SUMMARY OF THE INVENTION

An object of the present invention is to provide a broadcasting service paradigm for providing service to a plurality of viewers unlike the existing analog broadcasting for providing a broadcasting program of a broadcaster to viewers one-sidedly.

Another object of the present invention is to provide multicasting broadcasting service for providing broadcasting service including content desired by specific viewers, from among the programs of a broadcaster, to the specific viewers only.

In accordance with an aspect of the present invention, a multicasting broadcasting apparatus includes a reception unit configured to receive content from a user, a processor configured to inspect the content, perform IP encapsulation on the content, reconfigure a broadcasting frame so that the content does not interfere with other broadcasting signals, and generate a modulation signal comprising the content, and a transmission unit configured to broadcast the modulation signal to target receivers over a broadcasting network.

In accordance with another aspect of the present invention, a multicasting broadcasting method includes receiving content from a user, inspecting the content, performing IP encapsulation on the content, reconfiguring a broadcasting frame so that the content does not interfere with other broadcasting signals, generating a modulation signal comprising the content, and broadcasting the modulation signal to target receivers over a broadcasting network.

### BRIEF DESCRIPTION OF THE DRAWINGS

FIG. 1 shows an example of multicasting broadcasting in accordance with the present invention.

FIG. 2 shows an example of local multicasting broadcasting performed in accordance with the present invention.

FIG. 3 shows an example of nationwide multicasting broadcasting performed in accordance with the present invention.

FIG. 4 is a block diagram showing an example of an apparatus for performing multicasting broadcasting in accordance with the present invention.

### DETAILED DESCRIPTION OF THE EMBODIMENTS

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

The present invention relates to selectively providing broadcasting service to a plurality of users belonging to a specific group who wants to receive content. Hereinafter, a user may be a common viewer, company, institute, broadcaster, or broadcasting station. Unlike in the existing paradigm for providing broadcasting to all viewers, the present invention provides multicasting broadcasting for providing broadcasting service to some viewers who want the broadcasting service.

Examples of multicasting broadcasting in accordance with the present invention are described below.

<Multicasting Broadcasting Example 1: Multicasting Broadcasting for One Specific Area>

In accordance with the present invention, multicasting broadcasting service can be provided to receivers within one specific area, which is also called local broadcasting. For example, a target service area for local broadcasting can be within a spatially limited area, such as within a play park or within a shopping center.

(1) Broadcasting within a Play Park

An example in which multicasting broadcasting for a play park (e.g., Everland) is performed is described below.

For example, content, including information about event functions for visitors to a play park, information about a current state of users who use a specific ride, and information about restaurants within the play park or nearby thereof, can be produced in the play park (or produced by a different company), and a broadcaster can deliver the content within the play park in real time over wired/wireless Internet networks.

Here, the broadcaster can inspect the content produced in the play park and can check that there is no problem in broadcasting the content based on the inspection. After inspecting the content, the broadcaster can serve the content through a transmitter including the play park as its broadcasting range over a broadcasting network. Here, since the content has been subjected to IP encapsulation, the content can be broadcasted to only visitors to the play park.

(2) Broadcasting within a Shopping Center

An example in which multicasting broadcasting for a shopping center (e.g., a department store) is performed is described below.

For example, content, including information about event functions for the customers of a department store, information about new products, information about sales products, information about prices, information about discount event functions, and information about cultural event functions and restaurants, can be produced in a department store (or produced by a different company), and a broadcaster can deliver the content within the department store in real time over wired/wireless networks.

Here, a broadcaster can inspect the content produced in the department store and can check that there is no problem in broadcasting the content based on the inspection. After inspecting the content, the broadcaster can serve the content through a transmitter including the department store as its broadcasting range over a broadcasting network. Here, since the content has been subjected to IP encapsulation, the content can be broadcasted to only customers(or employees) who have entered the department store.

<Multicasting Broadcasting Example 2: Multicasting Broadcasting for a Plurality of Areas or the Whole Country>

Multicasting broadcasting service can be provided to employees who work at a specific company located in a plurality of areas or the whole country, or multicasting broadcasting service can be provided to employees who work at a specific institute (e.g., public service personnel who work at an information institute) located in a plurality of areas or the whole country.

(1) Multicasting Broadcasting Service for Employee Who Work at a Specific Company Located in a Plurality of Areas or the Whole Country

This is a case where broadcasting is delivered to employees who work at a specific company (e.g., employees who work at Hyundai Motor Company or Kia Motors Corp.).

If Hyundai Motor Company is located at Ulsan-si, Cheongju-si, etc., and Kia Motors Corp. is located at Gwangju-si, Asan-si, etc., broadcasting service can be provided to a plurality of areas or the whole country where Hyundai Motor Company and Kia Motors Corp. are located (i.e., Ulsan-si, Cheongju-si, Gwangju-si, Asan-si) through a transmitter including the areas as its broadcasting range.

Each of Hyundai Motor Company and Kia Motors Corp. can provide content produced by itself (or desired broadcasting) to its employees over a broadcasting network of a broadcaster, and a broadcaster can inspect the broadcasting content.

(2) Multicasting Broadcasting Service for Employees Who Work at a Specific Government Institute Located in a Plurality of Areas or the Whole Country

Broadcasting service can be provided to employees who work at a specific institute (e.g., public service personnel, police officers, fire fighters, ward officials, or down-block office officials) through a transmitter including the areas as its broadcasting range.

The multicasting broadcasting examples 1 and 2 described above are only illustrative, and the scope of the present invention is not limited to the aforementioned examples.

Business models for multicasting broadcasting are described below.

<Multicasting Broadcasting Business Model 1—Local Broadcasting>

For example, broadcasting service desired by a user can be provided to visitors to a play park. A user can provide visitors to a play park with information useful to view a play park and use entertainment.

A play park can attack more visitors, more induce the consumption of visitors, and increase earnings by adding this service cost to an admission fee.

For another example, broadcasting service desired by a user can be provided to customers who visit a department store. A user can more induce the consumption of consumers, increase the sales of products, and increase earnings by providing information useful for shopping to customers who visit a department store.

For yet another example, a broadcaster can provide a play park and a department store with paid broadcasting service on which a broadcasting network fee is levied. Accordingly, additional paid incomes in addition to advertising revenues can be obtained.

<Multicasting Broadcasting Business Model 2—Nationwide Broadcasting>

By providing paid nationwide broadcasting for content desired by a company or an institute, a broadcaster can obtain a new paid broadcasting revenue source and increase earnings.

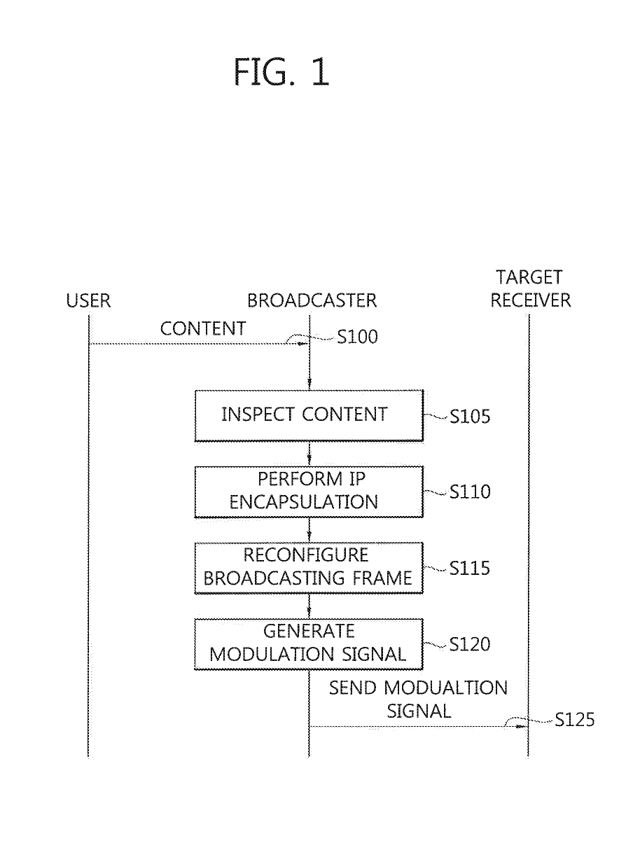

FIG. 1 shows an example of multicasting broadcasting in accordance with the present invention.

Referring to FIG. 1, a user transmits produced content (e.g., self-produced content) to a broadcaster at step 3100. For example, the content can be transmitted over an Internet network. For another example, the content can be transmitted through a microwave link.

The broadcaster can inspect the content received from the user at step S105.

The broadcaster performs IP encapsulation on the inspected content for the purpose of multicasting broadcasting at step S110. The content can be provided to only a target receiver to which the user wants to provide broadcasting by using the IP encapsulation. That is, IP encapsulation technology is used in order to identify the target receiver.

A broadcasting frame can be reconfigured so that a signal generated by the IP-encapsulated multicast content does not interfere with the existing broadcasting signal at step 3115.

A modulation signal including the content is generated at step S120. For example, the modulation signal can be an Orthogonal Frequency Division Multiplex (OFDM) signal.

The broadcaster broadcasts the modulation signal to the target receiver over a terrestrial wave fixed broadcasting network, a terrestrial wave mobile broadcasting network, or a cable broadcasting network at step S125.

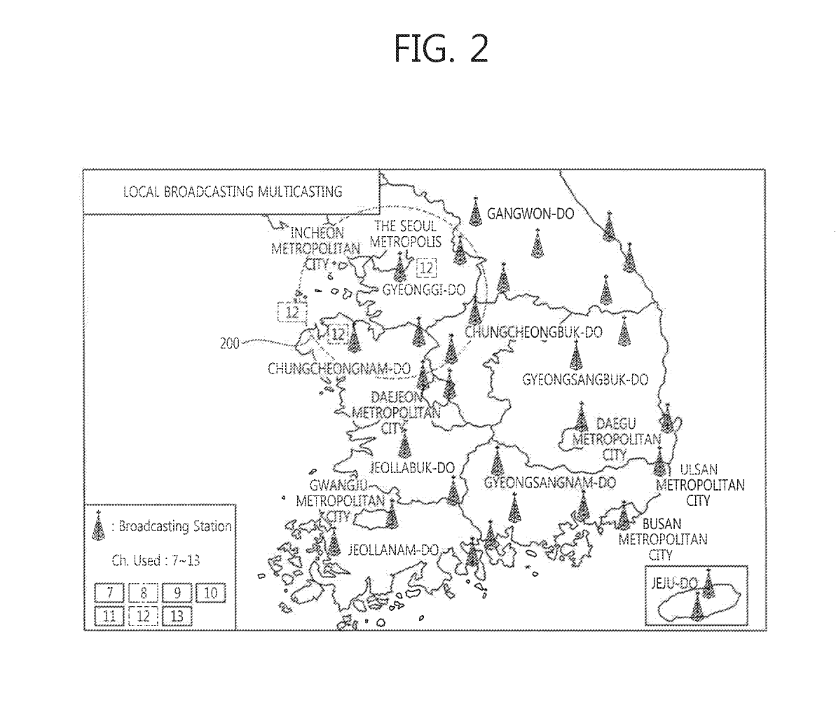

FIG. 2 shows an example of local multicasting broadcasting performed in accordance with the present invention. If target receivers are gathered at a specific area, such as a play park or a shopping center, multicasting broadcasting can be provided to the specific area through a transmitter included in a broadcasting range 200. FIG. 2 shows an example in which local multicasting broadcasting is provided to visitors to a play park, for example, Everland.

If on-going event functions, a current state of users who use a specific ride, and information about restaurants are sought to be provided to the visitors in real time, Everland can produce content in itself and deliver the produced content to a broadcaster over wired/wireless networks.

The broadcaster can check that there is no problem in broadcasting the produced content by inspecting the content.

After checking the content, the broadcaster can serve the content through a broadcasting transmitter at Seoul and Gyeonggi-do areas that includes Everland as its broadcasting range over a broadcasting network.

The broadcasted content can be provided to only persons who have entered Everland because the broadcasted content has been subjected to IP encapsulation.

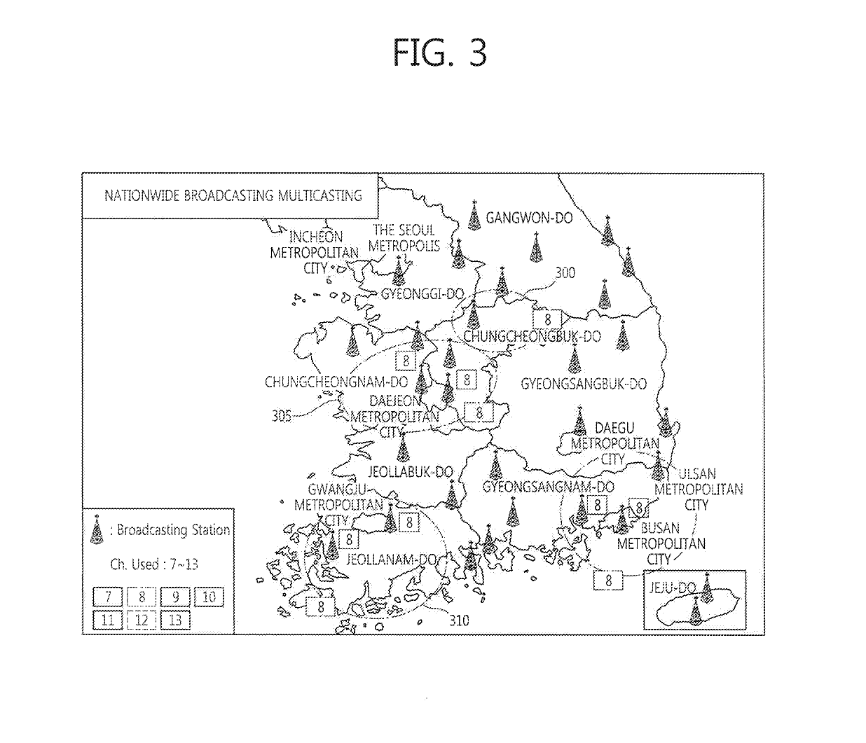

FIG. 3 shows an example of nationwide multicasting broadcasting performed in accordance with the present invention. If target receivers are distributed over several areas in the whole country, a user provides desired broadcasting service to the several areas where the target receivers are located through transmitters including the several areas as their broadcasting ranges. FIG. 3 shows an example in which Hyundai Motor Company and Kia Motors Corp. provide broadcasting service to their employees.

Referring to FIG. 3, Hyundai Motor Company is located at Ulsan-si, Cheongju-si, etc., and Kia Motors Corp. is located at Gwangju-si, Asan-si, etc. Multicasting broadcasting is provided to areas, such as Cheongju-si, Ulsan-si, Asan-si, and Gwangju-si, where Hyundai Motor Company and Kia Motors Corp. are located through transmitters including the areas as their broadcasting ranges.

More particularly, multicasting broadcasting is provided through a transmitter including a Hyundai Motor area 300 at Cheongju-si as its broadcasting range, a transmitter including a Hyundai Motor area 315 at Ulsan-si as its broadcasting range, a transmitter including a Kia Motors area 310 at Gwangju-si as its broadcasting range, and a transmitter including a Kia Motors area 305 at Asan-si as its broadcasting range. Hyundai Motor Company and Kia Motors Corp. can effectively provide desired multicasting broadcasting to employees over a broadcasting network of a broadcaster.

In this case, the broadcaster can inspect the broadcasting content.

The embodiment of FIG. 3 can also be applied to institutes that are distributed over several areas all over the country. For example, broadcasting service can be provided to nationwide public service personnel, nationwide police offices, nationwide fire stations, nationwide ward offices, or nationwide down-block offices.

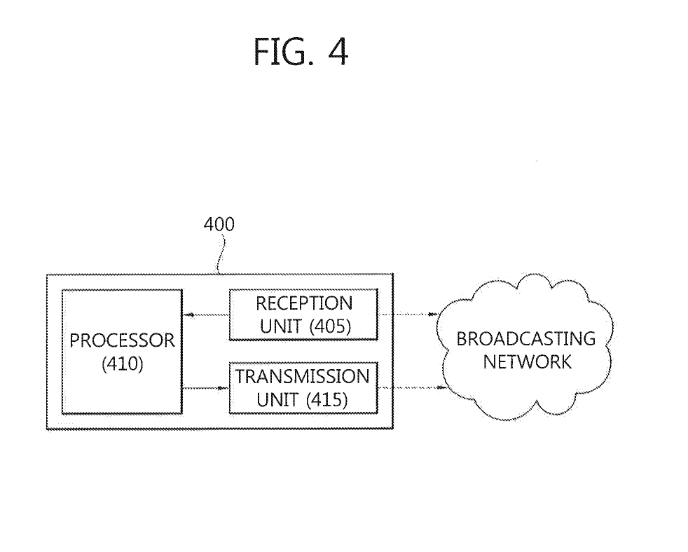

FIG. 4 is a block diagram showing an example of an apparatus for performing multicasting broadcasting in accordance with the present invention.

Referring to FIG. 4, the multicasting broadcasting apparatus 400 can include a reception unit 405, a processor 410, and a transmission unit 415.

The reception unit 405 can receive content produced by a user (e.g., self-produced content) from the user over an Internet network.

The processor 410 can inspect the received content.

Furthermore, the processor 410 can perform IP encapsulation on the inspected content for the purpose of multicasting broadcasting.

Furthermore, the processor 410 can reconfigure a broadcasting frame so that a signal generated by the IP-encapsulated multicast content does not interfere with the existing broadcasting signal.

Furthermore, the processor 410 can generate a modulation signal including the content. For example, the modulation signal can be an OFDM signal.

The transmission unit 415 provides multicasting service to target receivers by sending the modulation signal over a broadcasting network, such as a terrestrial wave fixed broadcasting network, a terrestrial wave mobile broadcasting network, or a cable broadcasting network of a broadcaster.

For example, the multicasting service can be multicasting broadcasting (e.g., local broadcasting) for one specific area.

For example, a target service area for the local broadcasting can be within a spatially limited area, such as within a play park or within a shopping center. Content, including information about event functions for visitors to a play park, information about a current state of users who use a specific ride, and information about restaurants within the play park or nearby thereof, can be produced in the play park (or produced by a different company), and the transmission unit 415 can deliver the content within the play park in real time over wired/wireless Internet networks. In some embodiments, content, including information about event functions for the customers of a department store, information about new products, information about sales products, information about prices, information about discount event functions, and information about cultural event functions and restaurants, can be produced in a department store (or produced by a different company), and transmission unit 415 can deliver the content within the department store in real time over wired/wireless networks.

For another example, the multicasting service can be multicasting broadcasting (e.g., nationwide broadcasting) for a plurality of areas or the whole country. For example, the multicasting service can be multicasting broadcasting service for employees who work at a specific company in a plurality of areas or the whole country. This corresponds to a case where broadcasting is delivered to employees who work at a specific company (e.g., employees who work at Hyundai Motor Company or Kia Motors Corp.). If Hyundai Motor Company is located at Ulsan-si, Cheongju-si, etc. and Kia Motors Corp. is located at Gwangju-si, Asan-si, etc., the multicasting broadcasting apparatus 400 can be an apparatus including a plurality of areas or the whole country (i.e., Ulsan-si, Cheongju-si, Gwangju-si, and Asan-si) where Hyundai Motor Company and Kia Motors Corp. are located as its broadcasting range.

Furthermore, the multicasting broadcasting apparatus 400 can deliver multicasting broadcasting to employees who work at a specific government institute in a plurality of areas or the whole country. The multicasting broadcasting apparatus 400 can be an apparatus including areas where employees (e.g., public service personnel, police officers, fire fighters, ward officials, or down-block office officials) work a specific institute as its broadcasting range.

The present invention is advantageous in that it is not necessary to install an additional transmitter and a target receiver for broadcasting is identified by IP encapsulation.

In accordance with the present invention, a broadcaster can provide paid broadcasting service and increase earnings.

In accordance with the present invention, since revenue sources for a broadcaster that depends on advertising revenues are increased through new paid broadcasting, the earnings of the broadcaster and a multicasting user can be increased.

A person having ordinary skill in the art to which the present invention pertains can substitute, modify, and change the present invention without departing from the technical spirit of the present invention from the description.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A multicasting broadcasting apparatus, comprising:
a reception unit configured to receive content from a user;
a processor configured to inspect the content, perform IP encapsulation on the content, reconfigure a broadcasting frame so that the content does not interfere with other broadcasting signals, and generate a modulation signal comprising the content; and
a transmission unit configured to broadcast the modulation signal to target receivers over a broadcasting network.

2. The multicasting broadcasting apparatus of claim 1, wherein:
the target receivers comprise receivers within a spatially limited play park, and
the content comprises information about on-going event functions, information about a current state of users who use specific rides, or information about restaurant within the play park or nearby thereof.

3. The multicasting broadcasting apparatus of claim 1, wherein:
the target receivers comprise receivers within a spatially limited department store, and
the content comprises information about on-going event functions, information about new products, information about sales products, information about prices, information about discount event functions, information about cultural event functions, or information about restaurants.

4. The multicasting broadcasting apparatus of claim 1, wherein:
the target receivers comprise receivers within a plurality of specific areas, and
the transmission unit includes at least one of the plurality of specific areas as its broadcasting range.

5. The multicasting broadcasting apparatus of claim 1, wherein:
the target receivers comprise employees within a plurality of specific areas where a specific company is located, and
the transmission unit includes at least one of the plurality of specific areas as its broadcasting range.

6. The multicasting broadcasting apparatus of claim 1, wherein:
the target receivers comprise public service personnel within a plurality of specific areas where a specific government institute is located, and
the transmission unit includes at least one of the plurality of specific areas as its broadcasting range.

7. The multicasting broadcasting apparatus of claim 6, wherein the public service personnel comprise policed officers, fire fighters, ward officials, or down-block office officials.

8. The multicasting broadcasting apparatus of claim 1, wherein the broadcasting network comprises at least one of a terrestrial wave fixed broadcasting network, a terrestrial wave mobile broadcasting network, and a cable broadcasting network.

9. A multicasting broadcasting method, comprising:
receiving content from a user;
inspecting the content;
performing IP encapsulation on the content;
reconfiguring a broadcasting frame so that the content does not interfere with other broadcasting signals;
generating a modulation signal comprising the content; and
broadcasting the modulation signal to target receivers over a broadcasting network.

10. The multicasting broadcasting method of claim 9, wherein:
the target receivers comprise receivers within a spatially limited play park, and
the content comprises information about on-going event functions, information about a current state of users who use specific rides, or information about restaurant within the play park or nearby thereof.

11. The multicasting broadcasting method of claim 9, wherein:
the target receivers comprise receivers within a spatially limited department store, and
the content comprises information about on-going event functions, information about new products, information about sales products, information about prices, information about discount event functions, information about cultural event functions, or information about restaurants.

12. The multicasting broadcasting method of claim 9, wherein:
the target receivers comprise receivers within a plurality of specific areas, and
the modulation signal is broadcasted by using at least one of the plurality of specific areas as its broadcasting range.

13. The multicasting broadcasting method of claim 9, wherein:
the target receivers comprise employees within a plurality of specific areas where a specific company is located, and
the modulation signal is broadcasted by using at least one of the plurality of specific areas as its broadcasting range.

14. The multicasting broadcasting method of claim 9, wherein:
the target receivers comprise public service personnel within a plurality of specific areas where a specific government institute is located, and
the modulation signal is broadcasted by using at least one of the plurality of specific areas as its broadcasting range.

15. The multicasting broadcasting method of claim 14, wherein the public service personnel comprise policed officers, fire fighters, ward officials, or down-block office officials.

16. The multicasting broadcasting method of claim 9, wherein the broadcasting network comprises at least one of a terrestrial wave fixed broadcasting network, a terrestrial wave mobile broadcasting network, and a cable broadcasting network.

17. The multicasting broadcasting method of claim 9, wherein the modulation signal is an Orthogonal Frequency Division Multiplex (OFDM) signal.
